(19) United States
(12) Patent Application Publication
(10) Pub. No.: US 2016/0005514 A1
(43) Pub. Date: Jan. 7, 2016

(54) METHOD FOR FORMING ELECTRONIC ELEMENT

(71) Applicant: EPISTAR CORPORATION, Hsinchu (TW)

(72) Inventors: Jai-Tai KUO, Taipei (TW); Yu-Hsi SUNG, Taipei (TW); Po-Chang CHEN, Taipei (TW)

(21) Appl. No.: 14/324,888

(22) Filed: Jul. 7, 2014

(51) Int. Cl. H01B 13/00; C23C 18/16; C25D 5/34; C23C 18/18

(52) U.S. Cl. CPC H01B 13/0026; C23C 18/182; C23C 18/1637; C25D 5/34

(57) ABSTRACT

Disclosed is a method for forming an electronic element. The method for forming an electronic element comprises: providing a first substrate comprising a compound comprising a metallic element and a non-metallic element; performing a first treatment by a laser radiation in a first region of the first substrate; and forming a first electrically conductive layer in the first region radiated by the laser.

### TECHNICAL FIELD

The application relates to a method for forming an electronic element, in particular to a method for forming an electronic element comprising an electrically conductive layer on a substrate.

### DESCRIPTION OF BACKGROUND ART

An electronic element having an electrically conductive layer on a substrate is widely used. For example, an antenna, a RFID (Radio Frequency Identification) tag, and a PCB (Printed Circuit Board) may comprise an electronic element having an electrically conductive layer on a substrate. A conventional method to form an electronic element with an electrically conductive layer on a substrate comprise sputtering the electrically conductive layer on the substrate and then etching away a part of the electrically conductive layer to define a pattern. There are many shortages in the conventional method. For example, the etched-away material of the electrically conductive layer is a waste and raises the cost. Further, since the material properties of the electrically conductive layer and the substrate are quite different, the adhesion between the electrically conductive layer and the substrate is weak, and peeling of the electrically conductive layer happens often. Still further, the resolution of the pattern of the electrically conductive layer formed by the etching method, such as the width of an electrically conductive line, is limited. As the demand for a small electronic device is increased, other method to provide a high resolution electrically conductive layer on a substrate is needed.

### SUMMARY OF THE DISCLOSURE

Disclosed is a method for forming an electronic element. The method for forming an electronic element comprises: providing a first substrate comprising a compound comprising a metallic element and a non-metallic element; performing a first treatment by a laser radiation in a first region of the first substrate; and forming a first electrically conductive layer in the first region radiated by the laser.

### BRIEF DESCRIPTION OF THE DRAWINGS

FIGS. 1A to 1C show the method for forming an electronic element in accordance with the first embodiment of the present application.

FIGS. 2A to 2D show the method for forming an electronic element in accordance with the second embodiment of the present application.

FIGS. 3A to 3E show the method for forming an electronic element in accordance with the third embodiment of the present application.

### DETAILED DESCRIPTION OF PREFERRED EMBODIMENTS

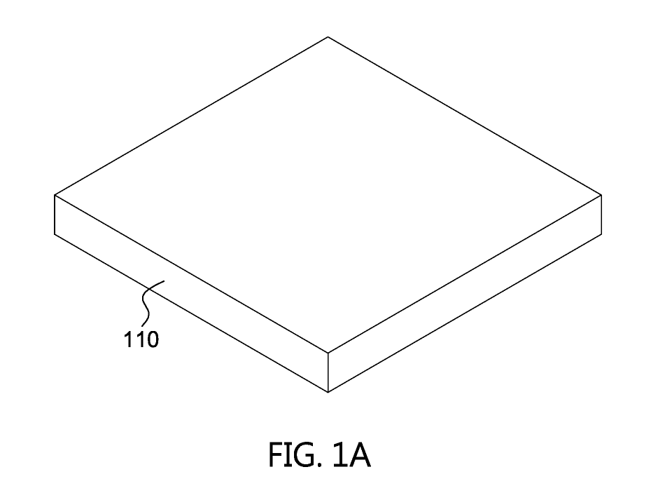

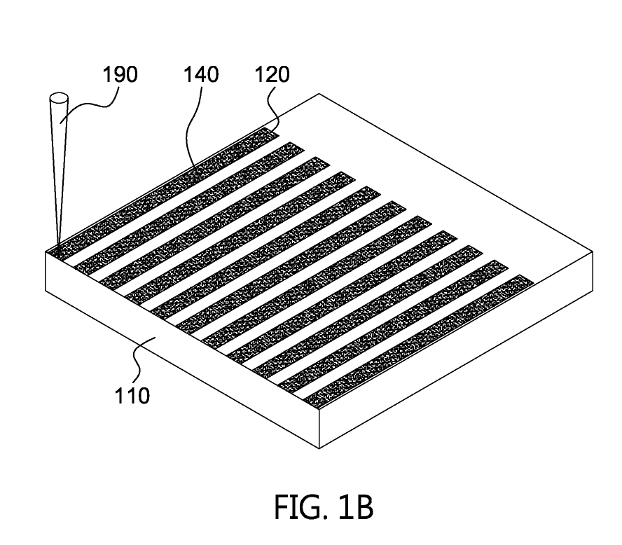

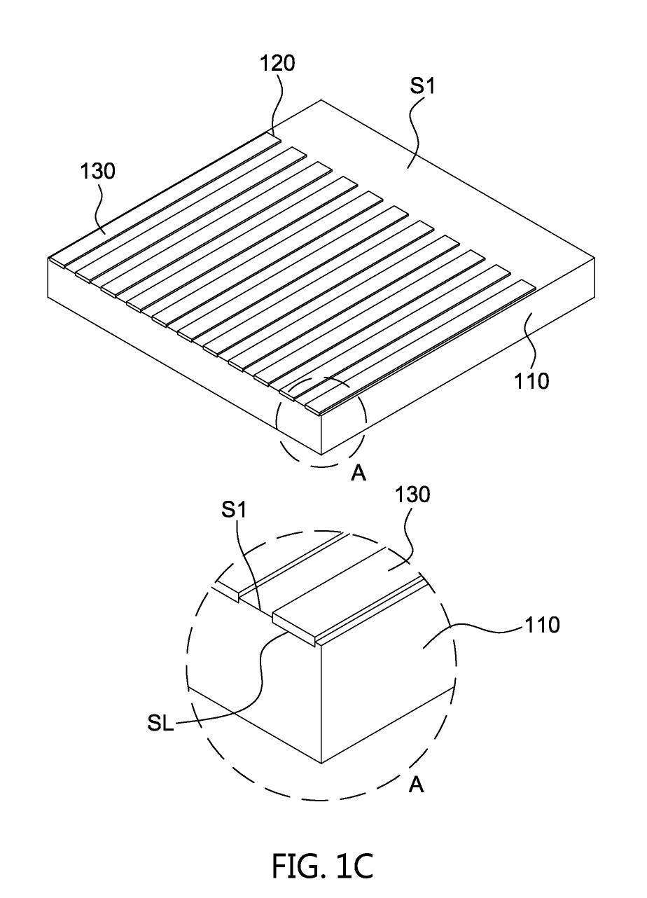

FIGS. 1A to 1C show the method for forming an electronic element in accordance with the first embodiment of the present application. An electronic element having an electrically conductive layer on a substrate is suitable for various electronic devices or applications. In the present embodiment, the electronic element is illustrated for an electrical connector with pins, wherein the electrically conductive layer functions as the pins. The electrical connector with pins is, for example, a PCI (Peripheral Component Interconnect) Card plugged in a PCI expansion slot of a computer.

As shown in FIG. 1A, the method for forming an electronic element comprises providing a first substrate 110, performing a first treatment by a laser radiation 190 in a first region 120 of the first substrate 110 as shown in FIG. 1B, and forming a first electrically conductive layer 130 in the first region 120 treated by the laser 190 as shown in FIG. 1C. The first electrically conductive layer 130 functions as the pins of the electrical connector. It is noted the first substrate 110 comprises a compound comprising a metallic element and a non-metallic element. The compound is electrically insulating. In the present embodiment, the compound comprises inorganic compound. For example, the first substrate 110 comprises metal oxide or metal nitride. The metal oxide may be Al₂O₃. The metal nitride may be AlN. The first substrate 110 may be a composite substrate or a monolithic substrate. The composite substrate may be, for example, a glass substrate with a layer of Al₂O₃ formed thereon. In the present embodiment, the first substrate 110 is a monolithic substrate. For example, the first substrate 110 may be a monolithic Al₂O₃ substrate or a monolithic AlN substrate.

In FIG. 1B, a seed layer 140 is formed on the first region 120 during the step of performing the first treatment by the laser radiation 190. There are covalent bonds existing between the metallic element and the non-metallic element of the first substrate 110, and the laser radiation 190 breaks some but not all covalent bonds associated with a metallic atom of the metallic element so there are dangling metallic atoms whose covalent bonds are broken. Those dangling metallic atoms form the seed layer 140. For example, when the first substrate 110 is an Al₂O₃ substrate or an AlN substrate, a seed layer 140 is formed and comprises Al. The seed layer 140 is used to facilitate plating to form the first electrically conductive layer 130. The laser radiation 190 for the first treatment can be YAG laser, IR laser or CO₂ laser. In the present embodiment, YAG laser with a wavelength of about 1064 nm and a power of 2-20 W is used on an Al₂O₃ substrate or an AlN substrate. To be more specific, a power of the YAG laser is about 5 W. In general, the power of the laser radiation 190 has to be sufficient to break some but not all covalent bonds associated with the metallic atom.

The method for forming the first electrically conductive layer 130 comprises electroless plating or electroplating. In the present embodiment, electroless plating is used. The first substrate 110 is immersed in a solution comprising a compound of a metal material which constitutes the first electrically conductive layer 130. For example, the first substrate 110 is immersed in a solution comprising a metal salt. In the present embodiment, the first substrate 110 is immersed in a solution comprising CuSO₄ to form a first electrically conductive layer 130 comprising Cu. In other embodiments, the first electrically conductive layer 130 may comprise nickel, silver, iron, tin, or gold.

As shown in FIG. 1C, a lower surface SL of the first electrically conductive layer 130 is below an upper surface S1 of the first substrate 110 because some material of the first substrate 110 is transformed as the aforementioned seed layer 140 which reacts in the plating process to form the first electrically conductive layer 130. In other words, a part of the first electrically conductive layer 130 is embedded in the first substrate 110, which makes the adhesion between the first electrically conductive layer 130 and the first substrate 110 stronger so there is no peeling of the first electrically conductive layer 130. An embedded depth of the first electrically conductive layer 130 (or the height between the lower surface SL of the first electrically conductive layer 130 and the upper surface S1 of the first substrate 110) is about 5˜20 μm. In the present embodiment, the depth is about 10 μm.

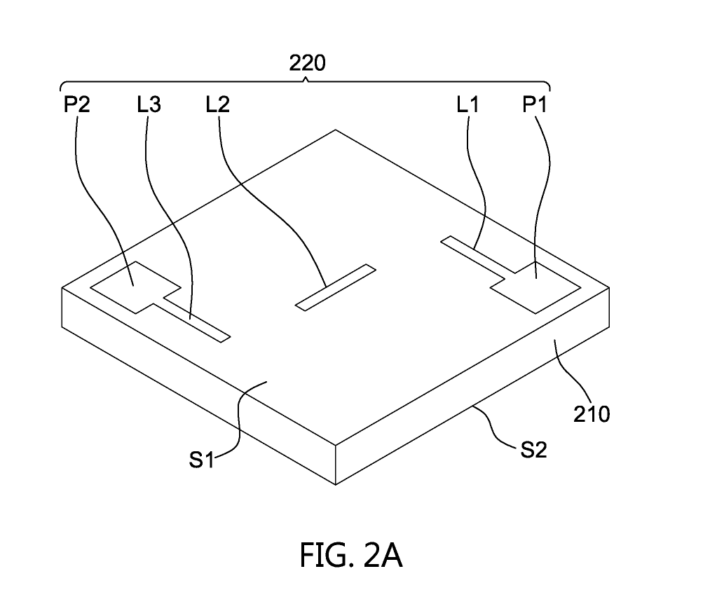

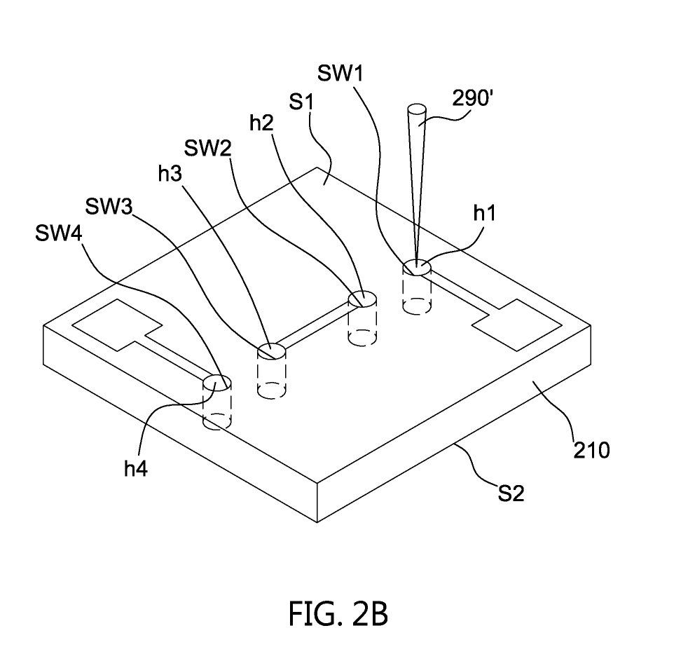

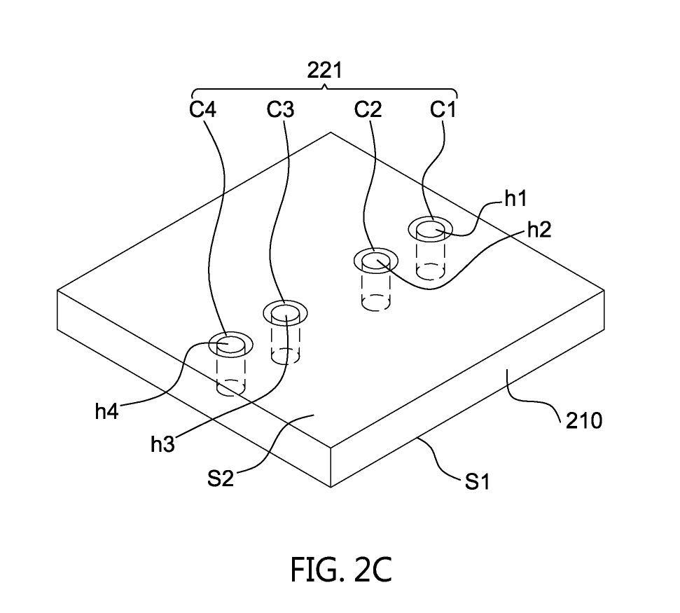

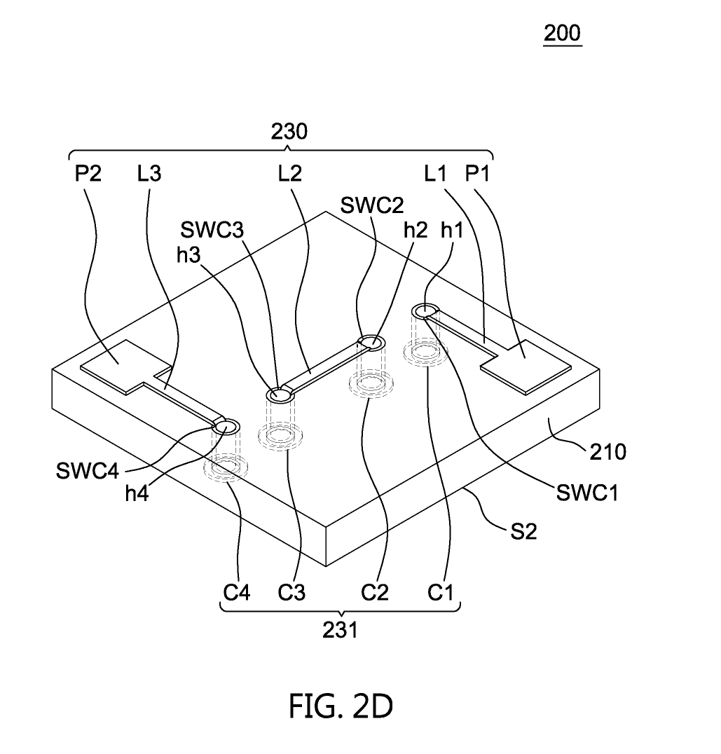

Viewing from different perspective, the first electrically conductive layer 130 is protruded from the upper surface S1 of the first substrate 110. In other embodiment, a part of the first electrically conductive layer 130 is protruded from the upper surface S1 of the first substrate 110 while the other part of the first electrically conductive layer 130 is substantially co-planar with the upper surface S1 of the first substrate 110. For some applications, the protrusion makes wire bonding or soldering on the first electrically conductive layer 130 easier. Therefore, when other electronic devices are disposed on the first substrate 110, an electrical contact can be easily formed between the first electrically conductive layer 130 and other electronic devices by wire bonding or soldering. The protrusion can be formed by controlling the power or the focus plane of the laser radiation 190. Taking FIG. 2B as an example, some areas of the first region 120 are irradiated by a relatively low laser power to form a shallower surface SL for forming the first electrically conductive layer 130 later while other areas are irradiated by a relatively high laser power to form a deeper surface SL. Because the whole first substrate 110 is immersed in the solution of the electroless plating, the first electrically conductive layer 130 is formed with a uniform thickness. Since the first electrically conductive layer 130 is formed with a uniform thickness, a part of the first electrically conductive layer 130 is protruded from the upper surface S1 of the first substrate 110 if it is formed on the shallower lower surface SL, while for the other part of the first electrically conductive layer 130 may be substantially co-planar with the upper surface S1 of the first substrate 110 if it is formed on the deeper lower surface SL. Wire bonding or soldering can be easily made on the protruded first electrically conductive layer 130.

FIGS. 2A to 2D show the method for forming an electronic element having an electrically conductive layer on a substrate in accordance with the second embodiment of the present application. In the present embodiment, the electronic element is illustrated for a PCB. As shown in FIG. 2A, the method for forming an electronic element comprises providing a first substrate 210, and performing a first treatment by a laser radiation (not shown) in a first region 220 on a first surface S1 of the first substrate 210. These steps and the selection of the first substrate 210 are substantially the same as the first two steps of the method illustrated in the first embodiment. The first region 220 in the present embodiment comprises patterns P1 and P2 for two pads, and L1, L2 and L3 for electrically conductive lines. And then, as shown in FIG. 2B, the method further comprises forming a hole h1 passing through the first substrate 210 and exposing a sidewall SW1 of the first substrate 210. The method to form the hole h1 comprises performing a second treatment on the sidewall SW1 of the first substrate 210. The second treatment may be using a laser radiation 290′ to perform a laser ablation to form the hole h1, or using a mechanical method, such as drilling or punching, to form the hole h1 and then imposing a laser radiation 290′ through the hole and on a sidewall SW1, wherein the former needs relatively higher energy for the laser radiation 290′ than the latter. For the latter method, the energy for the laser radiation 290′ is substantially the same as that illustrated in the first embodiment. When YAG laser with a wavelength of about 1064 nm is used for an Al₂O₃ substrate or an AlN substrate, a power of the laser radiation 290′ of 2˜20 W may be used. Holes h2, h3, and h4 may be formed in the same way as the way the hole h1 is formed. And then, as shown in FIG. 2C, the method further comprises performing a third treatment by a laser radiation (not shown) in a second region 221 on a second surface S2 of the first substrate 210. The first region 220 and the second region 221 are at opposite sides of the first substrate 220. The third treatment with a laser radiation may be similar to the first treatment with a laser radiation. The second region 221 in the present embodiment comprises circular patterns C1, C2, C3, and C4 which are suitable for soldering. Each of the circular patterns C1˜C4 surrounds the holes h1˜h4 from the top view, respectively. And finally, as shown in FIG. 2D, the method further comprises forming the first electrically conductive layer 230 in the first region 220 on the first surface S1, a second electrically conductive layer 231 in the second region 221 on the second surface S2, and forming a sidewall electrically conductive layer SWC1˜SWC4 on each of the sidewalls SW1˜SW4 at the same time. Similar to what is described in the first embodiment, because all the first region 220, the second region 221, and the sidewalls SW1˜SW4 are radiated by the laser, a seed layer (not shown) is formed in these areas. Electroless plating may be used and the first substrate 210 is immersed in a solution comprising a compound of a metal material which constitutes the electrically conductive layers.

As illustrated in FIG. 2D, in the present embodiment, a part of the first electrically conductive layer 230 on the first surface S1, a part of the second electrically conductive layer 231 on the second surface S2, and a part of the sidewall electrically conductive layers SWC1˜SWC4 may be connected. For example, the pad P1 and the electrically conductive line L1 of the first electrically conductive layer 230 are connected with the sidewall electrically conductive layer SWC1, and the sidewall electrically conductive layer SWC1 is connected with the circular pattern C1. In this way, the electronic element 200 such as a PCB is formed. Other electronic devices, such as light-emitting diodes, can be electrically connected to the first electrically conductive layer 230, the second electrically conductive layer 231, and the sidewall electrically conductive layer SWC1˜SWC4 as well. For example, a first light-emitting diode (not shown) may be disposed on the first surface S1 with its two leads plugged in the holes h1 and h2 and soldered with the circular patterns C1 and C2, respectively. Similarly, a second light-emitting diode (not shown) may be disposed on the first surface S1 with its two leads plugged in the holes h3 and h4 and soldered with the circular patterns C3 and C4, respectively. Thus, the first light-emitting diode and the second light-emitting diode are connected in series, and external power may be supplied via the pads P1 and P2.

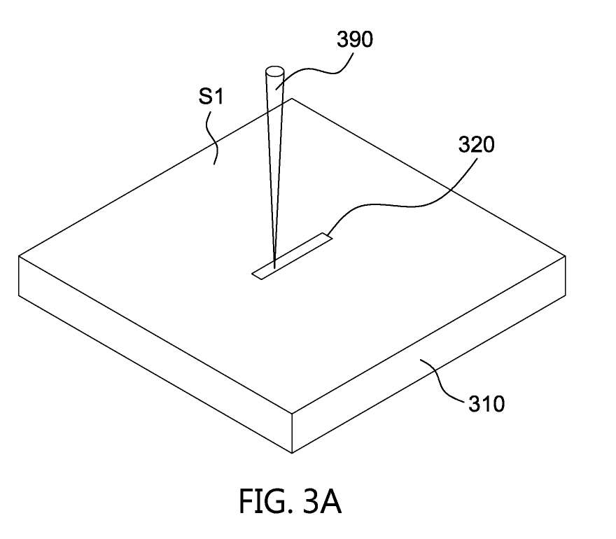

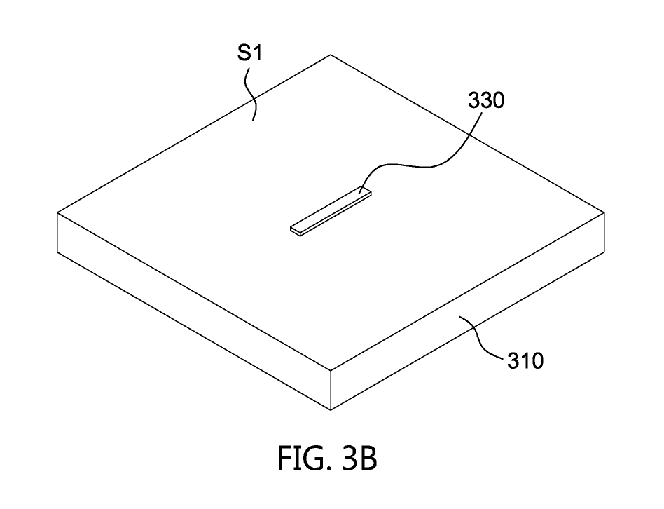

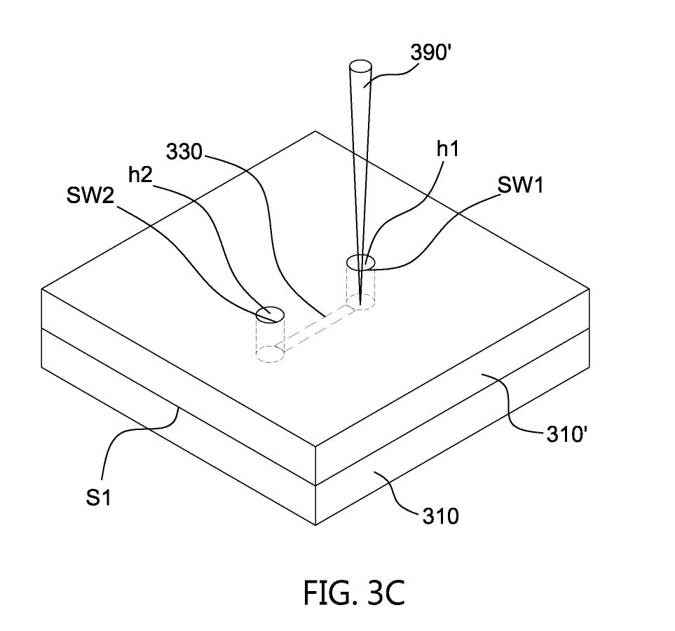

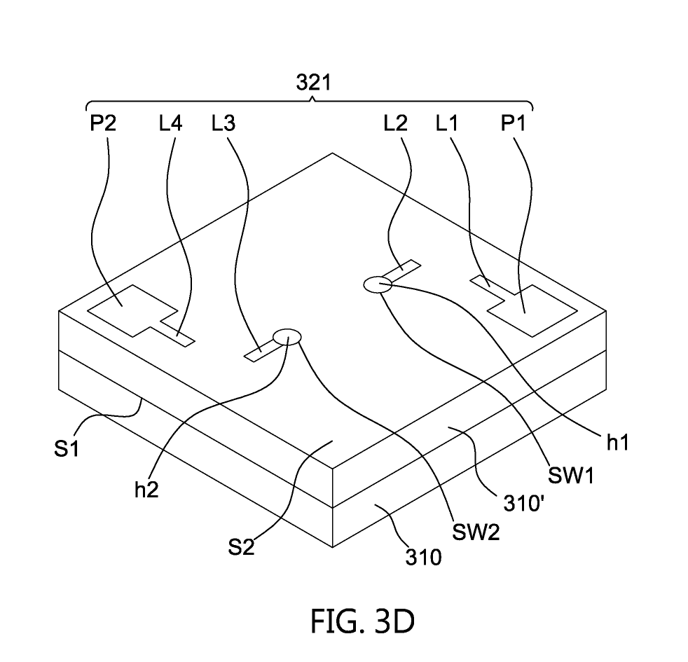

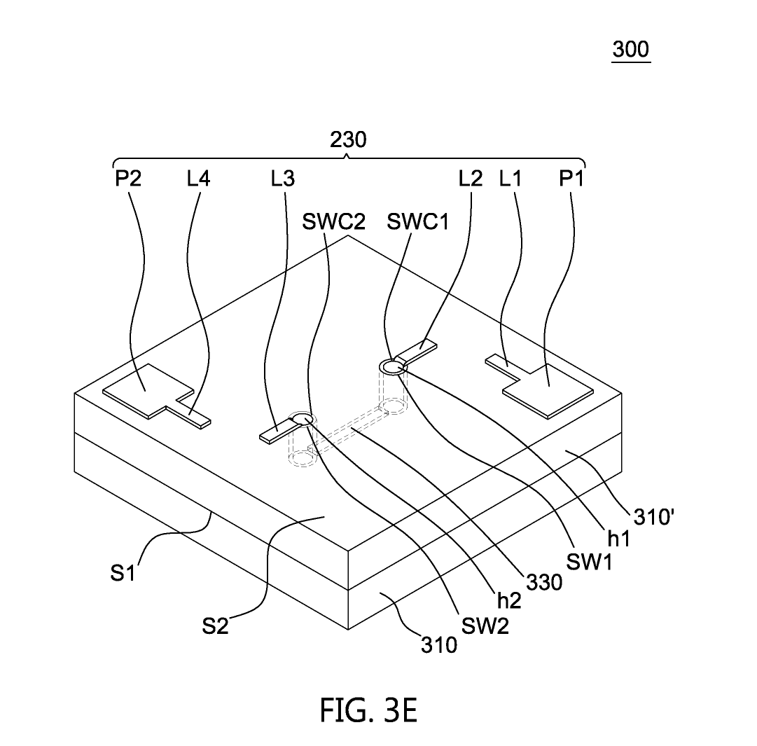

FIGS. 3A to 3E show the method for forming an electronic element having an electrically conductive layer on a substrate in accordance with the third embodiment of the present application. In the present embodiment, the electronic element is illustrated for a multi-layer PCB. As shown in FIG. 3A, the method for forming an electronic element comprises providing a first substrate 310; performing a first treatment by a laser radiation 390 in a first region 320 on a first surface S1 of the first substrate 310; and as shown in FIG. 3B, forming a first electrically conductive layer 330 in the first region 320 radiated by the laser 390. These steps and the selection of the first substrate 310 are substantially the same as the steps of the method illustrated in the first embodiment. The first region 320 in the present embodiment comprises a pattern for an electrically conductive line. And then, as shown in FIG. 3C, the method further comprises attaching a second substrate 310′ to the first substrate 310 such that the first electrically conductive layer 330 is disposed between the first substrate 310 and the second substrate 310′. The selection of the second substrate 310′ is the same as the selection of the first substrate 110 illustrated in the first embodiment. The second substrate 310′ may comprise the same material as that of the first substrate 310. And then the method further comprises forming a hole hl passing through the second substrate 310′ and exposing a sidewall SW1 of the second substrate 310′. The method to form the hole h1 comprises performing a second treatment on the sidewall SW1 of the first substrate 310. The second treatment may be using a laser radiation 390′ to perform a laser ablation to form the hole h1, or using a mechanical method, such as drilling or punching, to form the hole h1 and then imposing a laser radiation 390′ through the hole h1 and on a sidewall SW1, wherein the former needs relatively higher energy for the laser radiation 390′ than the latter. For the latter method, the energy for the laser radiation 390′ is substantially the same as that illustrated in the first embodiment. When YAG laser with a wavelength of about 1064 nm is used for an Al₂O₃ substrate or an AlN substrate, a power of the laser radiation 390′ of 2˜20 W may be used. A hole h2 may be formed in the same way as the hole h1 is formed. And then, as shown in FIG. 3D, the method further comprises performing a third treatment by a laser radiation (not shown) in a second region 321 on a second surface S2 of the second substrate 310′. The third treatment by a laser radiation may be similar to the first treatment by a laser radiation. The second surface S2 is far away from the first substrate 310. In other words, the first surface S1 and the second surface S2 are at opposite sides of the second substrate 310′. The second region 321 in the present embodiment comprises patterns P1 and P2 for two pads, and L1˜L4 for electrically conductive lines. Similar to what is described in the first embodiment, because the second region 321 and the sidewalls SW1˜SW2 are radiated by the laser, a seed layer (not shown) is formed in these areas. As shown in FIG. 3E, the method further comprises forming a sidewall electrically conductive layer SWC1 and SWC2 on the sidewalls SW1 and SW2 respectively, and forming a second electrically conductive layer 331 in the second region 321 at the same time. Electroless plating may be used and the second substrate 310′ (along with the first substrate 310) is immersed in a solution comprising a compound of a metal material which constitutes the electrically conductive layers.

As illustrated in FIG. 3E, in the present embodiment, a part of the first electrically conductive layer 330, a part of the second electrically conductive layer 331, and a part of the sidewall electrically conductive layer SWC1˜SWC2 may be connected. For example, the electrically conductive line L2 of second electrically conductive layer 331 is connected with the sidewall electrically conductive layer SWC1, and the sidewall electrically conductive layer SWC1 is connected with the first electrically conductive layer 330. In this way, the electronic element 300, such as a multi-layer PCB, is formed, wherein the multi-layer PCB comprises the first electrically conductive layer 330 and the second electrically conductive layer 331 at opposite sides of the second substrate 310′ (i.e. the first surface S1 and the second surface S2), and the first electrically conductive layer 330 and the second electrically conductive layer 331 are connected by the sidewall electrically conductive layer SWC1˜SWC2. Other electronic devices, such as light-emitting diodes, may be electrically connected to the first electrically conductive layer 330, the second electrically conductive layer 331, and the sidewall electrically conductive layer SWC1˜SWC2. For example, a first light-emitting diode (not shown) of SMD (Surface Mounted Devices) type may be disposed between the electrically conductive line L1 and L2 with each of its two leads connected to the electrically conductive line L1 and L2, respectively. Similarly, a second light-emitting diode (not shown) of SMD (Surface Mounted Devices) type may be disposed between the electrically conductive line L3 and L4 with each of its two leads connected to the electrically conductive line L3 and L4, respectively. Thus, the first light-emitting diode and the second light-emitting diode are connected in series, and the external power may be supplied via the pads P1 and P2.

The above-mentioned embodiments are only examples to illustrate the theory of the present invention and its effect, rather than be used to limit the present invention. Other alternatives and modifications may be made by a person of ordinary skill in the art of the present application without escaping the spirit and scope of the application, and are within the scope of the present application.

What is claimed is:

1. A method for forming an electronic element, comprising:
providing a first substrate comprising a compound comprising a metallic element and a non-metallic element;
performing a first treatment by a laser radiation in a first region of the first substrate; and
forming a first electrically conductive layer in the first region radiated by the laser.

2. The method for forming an electronic element as claimed in claim 1, wherein the compound comprises inorganic compound.

3. The method for forming an electronic element as claimed in claim 1, wherein the first substrate is a monolithic substrate.

4. The method for forming an electronic element as claimed in claim 1, wherein the compound comprises metal oxide or metal nitride.

5. The method for forming an electronic element as claimed in claim 1, wherein a covalent bond exists between the metallic element and the non-metallic element and the step of performing the first treatment breaks some but not all covalent bonds associated with a metallic atom of the metallic element.

6. The method for forming an electronic element as claimed in claim 1, wherein the step of performing the first treatment forms a seed layer for plating.

7. The method for forming an electronic element claimed in claim 1, wherein a lower surface of the first electrically conductive layer is below an upper surface of the first substrate.

8. The method for forming an electronic element as claimed in claim 1, further comprising a light-emitting diode electrically connected to the first electrically conductive layer.

9. The method for forming an electronic element as claimed in claim 1, wherein the first electrically conductive layer comprises copper, nickel, silver, iron, tin, or gold.

10. The method for forming an electronic element as claimed in claim 1, wherein the method for forming the first electrically conductive layer comprises electroless plating or electroplating.

11. The method for forming an electronic element as claimed in claim 1, further comprising forming a hole passing through the first substrate and exposing a sidewall of the first substrate.

12. The method for forming an electronic element as claimed in claim 11, further comprising performing a second treatment by a laser radiation on the sidewall of the first substrate.

13. The method for forming an electronic element as claimed in claim 12, further comprising forming a sidewall electrically conductive layer on the sidewall of the first substrate during the step of forming the first electrically conductive layer.

14. The method for forming an electronic element as claimed in claim 12, further comprising performing a third treatment by a laser radiation in a second region of the first substrate, wherein the first region and the second region are at opposite sides of the first substrate.

15. The method for forming an electronic element as claimed in claim 14, further comprising forming a second electrically conductive layer in the second region of the first substrate and forming a sidewall conductive layer on the sidewall of the first substrate during the step of forming the first electrically conductive layer.

16. The method for forming an electronic element as claimed in claim 1, further comprising attaching a second substrate to the first substrate such that the first electrically conductive layer is disposed between the first substrate and the second substrate.

17. The method for forming an electronic element as claimed in claim 16, wherein the second substrate comprises the same material as that of the first substrate.

18. The method for forming an electronic element as claimed in claim 16, further comprising forming a hole passing through the second substrate and exposing a sidewall of the second substrate.

19. The method for forming an electronic element as claimed in claim 18, further comprising performing a second treatment by a laser radiation on the sidewall of the second substrate and forming a sidewall conductive layer on the sidewall of the second substrate.

20. The method for forming an electronic element as claimed in claim 16, further comprising performing a second treatment by a laser radiation in a second region of the second substrate and forming a second electrically conductive layer in the second region, wherein the first region and the second region are at opposite sides of the second substrate.
